(19) United States
(12) Patent Application Publication
(10) Pub. No.: US 2023/0267644 A1
(43) Pub. Date: Aug. 24, 2023

(54) METHOD FOR ASCERTAINING A 6D POSE OF AN OBJECT

(71) Applicant: Robert Bosch GmbH, Stuttgart (DE)

(72) Inventors: Ning Gao, Nufringen (DE); Yumeng Li, Tuebingen (DE); Gerhard Neumann, Karlsruhe (DE); Hanna Ziesche, Leonberg (DE)

(21) Appl. No.: 18/168,205

(22) Filed: Feb. 13, 2023

(30) Foreign Application Priority Data
Feb. 21, 2022 (DE) 10 2022 201 768.4

(51) Int. Cl. G06T 7/73; G06T 7/50; G06V 10/44

(52) U.S. Cl. CPC G06T 7/73; G06T 7/50; G06V 10/44; G06T 2207/10024

(57) ABSTRACT

A method for ascertaining a 6D pose of an object. The method includes the following steps: providing image data, wherein the image data include target image data showing the object and labeled comparison image data relating to the object, and ascertaining the 6D pose of the object based on the provided image data using a meta-learning algorithm.

### CROSS REFERENCE

The present application claims the benefit under 35 U.S.C. § 119 of German Patent Application No. DE 10 2022 201 768.4 filed on Feb. 21, 2022, which is expressly incorporated herein by reference in its entirety.

### FIELD

The present invention relates to a method for ascertaining a 6D pose of an object with which the 6D pose of an object can be ascertained in a simple manner independent of the respective object category.

### BACKGROUND INFORMATION

A 6D pose is generally understood to be the position and orientation of objects. The pose in particular describes the transformation necessary to convert a reference coordinate system to an object-fixed coordinate system or coordinates of an optical sensor or camera coordinates to object coordinates, wherein each one is a Cartesian coordinate system and wherein the transformation is composed of a translation and a rotation.

The possible applications of pose estimation or the 6D pose of an object are many and varied. Camera relocalization, for example, can support the navigation of autonomous vehicles, for instance when a GPS (Global Positioning System) system is not working reliably or the accuracy is insufficient. GPS is also often not available for navigation in closed spaces. If a controllable system, for example a robotic system, is to interact with objects, for example grab them, their position and orientation in space has to also be precisely determined.

Conventional algorithms for estimating or ascertaining the 6D pose of an object are based on models that have been trained for a specific object category. A disadvantage here is that these models have to first be laboriously retrained for objects of another, different category before objects of this other, different category can be detected as well, which is associated with an increased consumption of resources. Different object categories are understood to be different types of objects or respective sets of logically connected objects.

U.S. Patent Application Publication No. US 2019/0304134 A1 describes a method, in which a first image is received, a class of an object in the first image is detected, a pose of the object in the first image is estimated, a second image of the object from a different viewing angle is received, a pose of the object in the second image is estimated, the pose of the object in the first image is combined with the pose of the object in the second image to create a verified pose, and the second pose is used to train a convolutional neural network (CNN).

### SUMMARY

An object of the present invention is to provide an improved method for ascertaining a 6D pose of an object and in particular a method for ascertaining a 6D pose of an object which can be applied to different categories of objects without much effort.

The object may be achieved with a method for ascertaining a 6D pose of an object according to the features of present invention.

The object furthermore may be achieved with a control device for ascertaining a 6D pose of an object according to the features of the present invention.

The object moreover may be achieved with a system for ascertaining a 6D pose of an object according to the features of present invention.

According to one example embodiment of the present invention, this object may be achieved by a method for ascertaining a 6D pose of an object. According to an example embodiment of the present invention, image data are provided, wherein the image data include target image data showing the object and labeled comparison image data relating to the object, and wherein the 6D pose of the object is ascertained based on the provided image data using a meta-learning algorithm.

Image data are understood to be data that are generated by scanning or optically recording one or more surfaces using an optical or electronic device or an optical sensor.

The target image data showing the object are image data, in particular current image data of a surface on which the object is currently located or positioned.

The comparison image data relating to the object are furthermore comparison or context data and in particular digital images which likewise represent the respective object for comparison or as a reference. Labeled data are understood to be data that are already known and have already been processed, for example from which features have already been extracted or from which patterns have already been derived.

A meta-learning algorithm is furthermore an algorithm of machine learning, which is configured to optimize the algorithm through independent learning and by drawing on experience. Such meta-learning algorithms are applied in particular to metadata, wherein the metadata can be characteristics of the respective learning problem, algorithm properties or patterns, for example, which were previously derived from the data. The application of such meta-learning algorithms in particular has the advantage that the performance of the algorithm can be increased and that the algorithm can be flexibly adapted to different problems.

The method according to the present invention may thus have the advantage that it can be flexibly applied to different object categories, and in particular new objects of a to-date unknown category, without having to first laboriously retrain the algorithm before objects of another, different category can be detected as well, which would be associated with an increased consumption of resources. Overall, therefore, this provides an improved method for ascertaining a 6D pose of an object which can be applied to different object categories without much effort.

The method can also comprise a step of acquiring current image data showing the object, wherein the acquired image data showing the object are provided as target image data. Current circumstances outside the actual data processing system, on which the ascertainment of the 6D pose is being carried out, are thus taken into account and incorporated in the method.

In one embodiment of the present invention, the step of ascertaining the 6D pose of the object based on the provided image data using a meta-learning algorithm further comprises extracting features from the provided image data, determining image points in the target image data showing the object, on the basis of the extracted features, determining key points on the object on the basis of the extracted features and information about the labeled comparison image data, for each key point, for each of the image points showing the object, determining an offset between the respective image point and the key point, and ascertaining the 6D pose based on the determined offsets for all key points.

The extracted or read-out features can be a specific pattern, for example a structure or condition of the object, or an external appearance of the object.

An image point is furthermore understood to be an element or piece of image data, for example a pixel.

Information about the labeled comparison image data is moreover understood to be information about the patterns or labels contained in the comparison image data.

A key point is understood to be a virtual point on the surface of an object which represents a point of geometric importance of the object, for example one of the vertices of the object.

Offset is furthermore understood to be a respective spatial displacement or a spatial distance between an image point and a key point.

The 6D pose can thus in particular be carried out in a simple manner and with a low consumption of resources, for example comparatively low memory and/or processor capacities, without having to first laboriously retrain the algorithm before objects of another, different category can be detected as well.

The image data can also be image data comprising depth information.

In this context, depth information is understood to be information about the spatial depth or spatial effect of an object represented or depicted in the image data.

An advantage of the image data including depth information is that the accuracy of the ascertainment of the 6D pose of the object can be increased even further.

However, the image data including depth information are only one possible embodiment. The image data can also be only RGB data, for example.

A further embodiment of the present invention also provides a method for controlling a controllable system, wherein a 6D pose of an object is first ascertained using an above-described method for ascertaining a 6D pose of an object and the controllable system is then controlled based on the ascertained 6D pose of the object.

The at least controllable system can be a robotic system, for example, wherein the robotic system can then, for example, be a gripping robot. Moreover, however, the system can also be a system for controlling or navigating an autonomously driving motor vehicle, for example, or a system for facial recognition.

Such a method may have the advantage that the control of the controllable system is based on a 6D pose of an object ascertained using an improved method for ascertaining a 6D pose of an object, which can be applied to different object categories, and in particular new objects of a to-date unknown category, without much effort. The control of the controllable system is in particular based on a method that can be flexibly applied to different object categories, without having to first laboriously retrain the respective algorithm before objects of another, different category can be detected as well, which would be associated with an increased consumption of resources.

A further embodiment of the present invention moreover also provides a control device for ascertaining a 6D pose of an object, wherein the control device comprises a provision unit, which is configured to provide image data, wherein the image data includes target image data showing the object, and labeled comparison image data relating to the object, and a first ascertainment unit which is configured to determine the 6D pose of the object based on the provided image data using a meta-learning algorithm.

Such a control device may have the advantage that it can be used to flexibly ascertain the 6D pose of an object even of different object categories, and in particular new objects of a to-date unknown category, without having to first laboriously retrain the respective algorithm implemented in the control device before objects of another different category can be detected as well, which would be associated with an increased consumption of resources. Overall, therefore, this provides an improved control device for ascertaining a 6D pose of an object which can be applied to different object categories without much effort.

The first ascertainment unit can furthermore comprise an extraction unit which is configured to extract features from the provided image data, a first determination unit which is configured to determine image points in the target image data showing the object on the basis of the extracted features, a second determination unit which is configured to determine key points on the object on the basis of the extracted features and information about the labeled comparison image data, a third determination unit which is configured, for each key point, for each of the image points showing the object, to determine an offset between the respective image point and the key point, and a second ascertainment unit which is configured to ascertain the 6D pose based on the determined offsets for all key points.

The control device can thus in particular be configured to ascertain the 6D pose in a simple manner and with a low consumption of resources, for example comparatively low memory and/or processor capacities, without having to first laboriously retrain the respective, underlying algorithm before objects of another, different category can be detected as well.

A further example embodiment of the present invention moreover also provides a system for ascertaining a 6D pose of an object, wherein the system comprises an above-described control device for ascertaining a 6D pose of an object and an optical sensor which is configured to acquire the target image data showing the object.

A sensor, which is also referred to as a detector or (measuring) probe, is a technical component that can acquire certain physical or chemical properties and/or the material characteristics of its surroundings qualitatively, or quantitatively as a measured variable. Optical sensors in particular consist of a light emitter and a light receiver, wherein the light receiver is configured to evaluate light emitted by the light emitter; for example in terms of intensity, color or transit time.

Such a system may have the advantage that it can be used to flexibly ascertain the 6D pose of an object even of different object categories, and in particular new objects of a to-date unknown category, without having to first laboriously retrain the respective implemented algorithm before objects of another different category can be detected as well, which would be associated with an increased consumption of resources. Overall, therefore, this provides an improved system for ascertaining a 6D pose of an object which can be applied to different object categories without much effort.

In one example embodiment of the present invention, the optical sensor is an RGB-D sensor.

An RGB-D sensor is an optical sensor that is configured to acquire associated depth information in addition to RGB data.

An advantage of the acquired image data including depth information is again that the accuracy of the ascertainment of the 6D pose of the object can be increased even further.

However, the optical sensor being an RGB-D sensor is only one possible embodiment. The optical sensor can also only be an RGB sensor, for example.

A further embodiment of the present invention moreover also provides a control device for controlling a controllable system, wherein the control device comprises a receiving unit for receiving a 6D pose of the object ascertained by an above-described control device for ascertaining a 6D pose of an object and a control unit which is configured to control the system based on the ascertained 6D pose of the object.

Such a control device may have the advantage that the control of the controllable system is based on a 6D pose of an object ascertained using an improved control device for ascertaining a 6D pose of an object, which can be applied to different object categories, and in particular new objects of a to-date unknown category, without much effort. The control of the controllable system is in particular based on a control device that is configured to flexibly ascertain the 6D pose of an object even of different object categories, without having to first laboriously retrain the respective implemented algorithm before objects of another, different category can be detected as well, which would be associated with an increased consumption of resources.

A further embodiment of the present invention furthermore also specifies a system for controlling a controllable system, wherein the system comprises a controllable system and an above-described control device for controlling the controllable system.

Such a system may have the advantage that the control of the controllable system is based on a 6D pose of an object ascertained using an improved control device for ascertaining a 6D pose of an object, which can be applied to different object categories without much effort. The control of the controllable system is in particular based on a control device that is configured to flexibly ascertain the 6D pose of an object even of different object categories and in particular new objects of a to-date unknown category, without having to first laboriously retrain the respective implemented algorithm before objects of another, different category can be detected as well, which would be associated with an increased consumption of resources.

In summary, it can be said that the present invention provides a method for ascertaining a 6D pose of an object with which the 6D pose of an object can be ascertained in a simple manner independent of the respective object category.

The described configurations and further developments can be combined with one another as desired.

Other possible configurations, further developments and implementations of the present invention also include not explicitly mentioned combinations of features of the present invention described above or in the following with respect to the embodiment examples.

### BRIEF DESCRIPTION OF THE DRAWINGS

The figures are intended to provide a better understanding of the embodiments of the present invention. They illustrate embodiments and, in connection with the description, serve to explain principles and concepts of the present invention.

Other embodiments and many of the mentioned advantages will emerge with reference to the figures. The shown elements of the figures are not necessarily drawn to scale with respect to one another.

FIG. 1 shows a flow chart of a method for ascertaining a 6D pose of an object according to embodiments of the present invention.

FIG. 2 shows a schematic block diagram of a system for ascertaining a 6D pose of an object according to example embodiments of the present invention.

### DETAILED DESCRIPTION OF EXAMPLE EMBODIMENTS

Unless otherwise stated, the same reference signs refer to the same or functionally identical elements, parts or components in the figures.

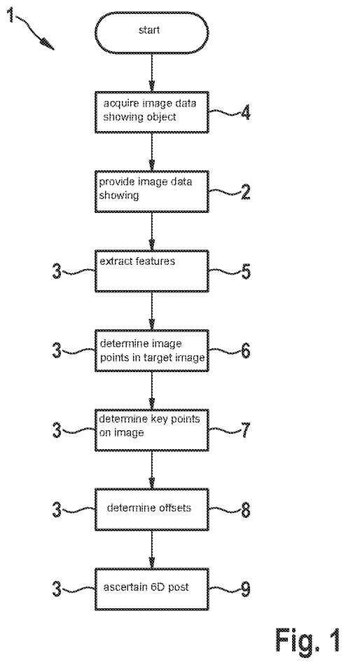

FIG. 1 shows a flow chart of a method for ascertaining a 6D pose of an object 1 according to embodiments of the present invention.

A 6D pose is generally understood to be the position and orientation of objects. The pose in particular describes the transformation necessary to convert a reference coordinate system to an object-fixed coordinate system or coordinates of an optical sensor or camera coordinates to object coordinates, wherein each one is a Cartesian coordinate system and wherein the transformation consists of a translation and a rotation.

The possible applications of pose estimation or the 6D pose of an object are many and varied. Camera relocalization, for example, can support the navigation of autonomous vehicles, for instance when a GPS (Global Positioning System) system is not working reliably or the accuracy is insufficient. GPS is also often not available for navigation in closed spaces. If a controllable system, for example a robotic system, is to interact with objects, for example grab them, their position and orientation in space has to also be precisely determined.

Conventional algorithms for estimating or ascertaining the 6D pose of an object are based on models that have been trained for a specific object category. The disadvantage here is that these models have to first be laboriously retrained for objects of another, different category before objects of this other, different category can be detected as well, which is associated with an increased consumption of resources. Different object categories are understood to be different types of objects or respective sets of logically connected objects.

As FIG. 1 shows, the method 1 comprises a step 2 of providing image data, wherein the image data include target image data showing the object and labeled comparison image data relating to the object and a step 3 of ascertaining the 6D pose of the object based on the provided image data using a meta-learning algorithm.

The shown method 1 thus has the advantage that it can be flexibly applied to different object categories, and in particular new objects of a to-date unknown category, without having to first laboriously retrain the algorithm before objects of another, different category can be detected as well, which would be associated with an increased consumption of resources. Overall, therefore, this provides an improved method 1 for ascertaining a 6D pose of an object which can be applied to different object categories, and in particular new objects of a to-date unknown category, without much effort.

As FIG. 1 further shows, the method 1 also comprises a step 4 of acquiring current image data showing the object, wherein the image data showing the are subsequently provided as target image data.

According to the embodiments of FIG. 1, the meta-learning algorithm in particular includes the application of a conditional neural process (CNP), wherein the conditional neural process comprises a segmentation and a detection of key points.

The step 3 of ascertaining the 6D pose of the object based on the provided image data using a meta-learning algorithm in particular comprises a step 5 of extracting features from the provided image data, a step 6 of determining image points in the target image data showing the object, on the basis of the extracted features, a step 7 of determining key points on the object on the basis of the extracted features and information about the labeled comparison image data, a step 8 of determining, for each key point, for each of the image points showing the object, an offset between the respective image point and the key point, and a step 9 of ascertaining the 6D pose based on the determined offsets for all key points.

The step 5 of extracting features from the provided image data can in particular comprise extracting appearances and/or other geometric information from at least a portion of the provided image data or at least a portion of the image points included in the provided image data and a respective learning of these features.

The step 6 of determining image points in the target image data showing the object on the basis of the extracted features in particular comprises identifying new objects, in particular new objects of a to-date unknown object category, in the image data and a respective differentiation between new and old objects shown in the image data. The identification can in particular be based on a correlation between the comparison image data and information about the comparison image data, in particular via the labels assigned to the comparison image data, and the features extracted in step 5.

The step 7 of determining key points on the object on the basis of the extracted features and information about the labeled comparison image data can further comprise predicting or deriving previously known key points in object coordinates on the basis of the information about the labeled comparison data, wherein a graph characterizing the key points may be produced as well.

The step 8 of determining, for each key point, for each of the image points showing the object, an offset between the respective image point and the key point can include a respective determination of the individual offsets on the basis of a multilayer perceptron or a graph neural network which has in each case been trained, for example based on historical data relating to other categories of objects.

The step 9 of ascertaining the 6D pose based on the determined offsets for all key points can further include applying a regression algorithm and in particular the least square fitting method.

The ascertained 6D pose of the object can then be used to control a controllable system, for example, for instance to control a robot arm to grab the object. However, the ascertained 6D pose can furthermore also be used to control or navigate an autonomous vehicle on the basis of an identified target vehicle, for example, or for facial recognition.

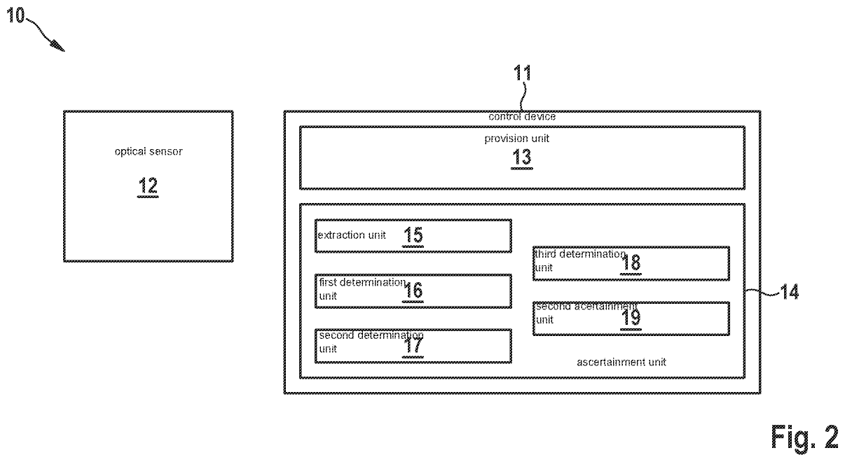

FIG. 2 shows a schematic block diagram of a system 10 for ascertaining a 6D pose of an object according to embodiments of the present invention.

As FIG. 2 shows, the shown system 10 comprises a control device for ascertaining a 6D pose of an object 11 and an optical sensor 12 which is configured to acquire target image data showing the object.

The control device for ascertaining a 6D pose of an object 11 is configured to carry out an above-described method for ascertaining a 6D pose of an object. According to the embodiments of FIG. 2, the control device for ascertaining a 6D pose of an object 11 in particular comprises a provision unit 13 which is configured to provide image data, wherein the image data includes target image data showing the object, and labeled comparison image data relating to the object, and a first ascertainment unit 14 which is configured to ascertain the 6D pose of the object based on the provided image data using a meta-learning algorithm.

The provision unit can in particular be a receiver, which is configured to receive image data. The ascertainment unit can furthermore be implemented on the basis of a code, for example, which is stored in a memory and can be executed by a processor.

As FIG. 2 further shows, the first ascertainment unit 14 further comprises an extraction unit 15 which is configured to extract features from the provided image data, a first determination unit 16 which is configured to determine image points in the target image data showing the object on the basis of the extracted features, a second determination unit 17 which is configured to determine key points on the object on the basis of the extracted features and information about the labeled comparison image data, a third determination unit 18 which is configured, for each key point, for each of the image points showing the object, to determine an offset between the respective image point and the key point, and a second ascertainment unit 19 which is configured to ascertain the 6D pose based on the determined offsets for all key points.

The extraction unit, the first determination unit, the second determination unit, the third determination unit and the second ascertainment unit can again be implemented on the basis of a code, for example, which is stored in a memory and can be executed by a processor.

The optical sensor 12 is in particular configured to provide or acquire the target image data processed by control device 11.

According to the embodiments of FIG. 2, the optical sensor 12 is in particular an RGB-D sensor.

What is claimed is:

1. A method for ascertaining a 6D pose of an object, the method comprising the following steps:
providing image data, the image data including target image data showing the object and labeled comparison image data relating to the object; and
ascertaining the 6D pose of the object based on the provided image data using a meta-learning algorithm.

2. A method according to claim 1, further comprising acquiring current image data showing the object, wherein the acquired current image data showing the object is provided as the target image data.

3. The method according to claim 1, wherein the step of ascertaining the 6D pose of the object based on the provided image data using a meta-learning algorithm includes the following steps:
extracting features from the provided image data;
determining image points in the target image data showing the object based on the extracted features;
determining key points on the object based on the extracted features and information about the labeled comparison image data;
for each key point of the key points, for each respective image point of the image points showing the object, determining an offset between the respective image point and the key point; and
ascertaining the 6D pose based on the determined offsets for all key points.

4. The method according to claim 1, wherein the image data include depth information.

5. A method for controlling a controllable system, comprising the following steps:
ascertaining a 6D pose of an object by:
providing image data, the image data including target image data showing the object and labeled comparison image data relating to the object, and
ascertaining the 6D pose of the object based on the provided image data using a meta-learning algorithm; and
controlling the controllable system based on the ascertained 6D pose of the object.

6. A control device configured to ascertain a 6D pose of an object, the control device comprising:
a provision unit configured to provide image data, wherein the image data include target image data showing the object and labeled comparison image data relating to the object; and
a first ascertainment unit configured to ascertain the 6D pose of the object based on the provided image data using a meta-learning algorithm.

7. The control device according to claim 6, wherein the first ascertainment unit includes:
an extraction unit configured to extract features from the provided image data;
a first determination unit configured to determine image points in the target image data showing the object based on the extracted features;
a second determination unit configured to determine key points on the object based on the extracted features and information about the labeled comparison image data;
a third determination unit configured, for each key point of the key points, for each respective image point of the image points showing the object, to determine an offset between the respective image point and the key point; and
a second ascertainment unit configured to ascertain the 6D pose based on the determined offsets for all key points.

8. A system for ascertaining a 6D pose of an object, the system comprising:
a control device for ascertaining a 6D pose of an object including:
a provision unit configured to provide image data, wherein the image data include target image data showing the object and labeled comparison image data relating to the object; and
a first ascertainment unit configured to ascertain the 6D pose of the object based on the provided image data using a meta-learning algorithm; and
an optical sensor configured to acquire the target image data showing the object.

9. The system according to claim 8, wherein the optical sensor is an RGB-D sensor.

10. A control device for controlling a controllable system, the control device comprising:
a receiving unit configured to receive a 6D pose of the object ascertained by a control device configured to ascertain a 6D pose of an object including:
a provision unit configured to provide image data, wherein the image data include target image data showing the object and labeled comparison image data relating to the object, and
a first ascertainment unit configured to ascertain the 6D pose of the object based on the provided image data using a meta-learning algorithm; and
a control unit configured to control the controllable system based on the ascertained 6D pose of the object.

11. A system configured to control a controllable system, the system comprising:
the controllable system; and
a control device for controlling the controllable system including:
a receiving unit configured to receive a 6D pose of the object ascertained by a control device configured to ascertain a 6D pose of an object including:
a provision unit configured to provide image data, wherein the image data include target image data showing the object and labeled comparison image data relating to the object, and
a first ascertainment unit configured to ascertain the 6D pose of the object based on the provided image data using a meta-learning algorithm; and
a control unit configured to control the controllable system based on the ascertained 6D pose of the object.
